(19) United States
(12) Patent Application Publication
(10) Pub. No.: US 2017/0247958 A1
(43) Pub. Date: Aug. 31, 2017

(54) Modular Pressure Control and Drilling Waste Management Apparatus for Subterranean Borehole

(71) Applicants: M-I L.L.C., Houston, TX (US); Mantovani & Vicentini S.R.L., Ferrara (IT)

(72) Inventors: Jamt Alfonzo Nunez, The Woodlands, TX (US); George Paul Delahoussaye, St. Martinville, LA (US); Stefano Spaccamonte, Ferrara (IT); Antonio Spinello, Ferrara (IT)

(21) Appl. No.: 15/513,555

(22) PCT Filed: Sep. 22, 2015
(86) PCT No.: PCT/US15/51434

§ 371 Date: Mar. 23, 2017

Related U.S. Application Data
(60) Provisional application No. 62/055,316, filed on Sep. 25, 2014.

(51) Int. Cl. E21B 21/06; B01D 21/26; E21B 21/10; B01D 19/00; E21B 41/00; E21B 21/08

(52) U.S. Cl. CPC E21B 21/067; E21B 21/065; E21B 41/00; E21B 21/08; E21B 21/106; B01D 19/0063; B01D 21/267; B01D 19/0057

(57) ABSTRACT

A method comprises controlling an operating pressure of a fluid from a borehole. The fluid comprises solids and entrained gas. The method further comprises removing at least a portion of the entrained gas from the fluid at an upstream location. The method further comprises removing residual entrained gas from the fluid at a downstream location. The method further comprises separating at least a portion of the solids from the fluid. The method further comprises circulating the separated fluid back to the borehole. Separating of solids occurs after the removing of entrained gases from the fluid at the downstream location.

### CROSS-REFERENCE TO RELATED APPLICATIONS

The present document is based on and claims priority to U.S. Provisional Application Ser. No. 62/055,316, filed Sep. 25, 2014, which is incorporated herein by reference in its entirety.

### BACKGROUND

The rigs used to drill many oil and/or gas wells currently enjoy much smaller footprints than oil and/or gas wells of the past. Technology, such as coiled tubing operations, has led to a decrease in the space for performing drilling and/or completion operations on oil or gas wells and a decrease in the time spent preparing for and performing such operations.

Coiled tubing operations include coiled tubing drilling, where downhole mud motors turn the bit to deepen a borehole. Coiled tubing drilling is useful in applications such as drilling slimmer wells and for areas where a small rig footprint is useful addition, coiled tubing operations are used in reentering wells and drilling underbalanced.

In underbalanced drilling, the amount of pressure (or force per unit area) exerted on a formation exposed in a borehole is less than the internal fluid pressure of that formation. If sufficient porosity and permeability exist, formation fluids enter the borehole.

Other coiled tubing operations involve coiled tubing services. Such services include fracturing and completions to enhance the overall production of a well. Hydraulic fracturing is a stimulation treatment performed on oil and gas wells in low-permeability reservoirs. Specially engineered fluids are pumped into the portion of the reservoir to be treated at a high pressure and rate, causing a vertical fracture to open. Proppant, such as grains of sand of a particular size, is mixed with the treatment fluid to keep the fracture open when the treatment is complete.

In addition to coiled tubing operations, traditional drill pipe operations have seen reductions in the area accommodating the equipment associated with drilling, completions, and production of a well. This is particularly true for offshore rigs where floor space is easily quantified.

Because less space is available for drilling rigs, space allocated to various pieces of equipment and systems has decreased and as a result there is less footprint and preparation time available for pressure control equipment and drilling waste management equipment as well as other associated equipment.

### BRIEF DESCRIPTION OF THE DRAWINGS

These and other aspects are better understood when the following detailed description is read with reference to the accompanying drawings, in which:

FIG. 1 is a top view of the pressure control section of the modular apparatus;

FIG. 2 is a front view of the gas separator section of the modular apparatus;

FIG. 3 is a side view of the gas separator section of the modular apparatus;

FIG. 4 is a top view of the gas separator section of the modular apparatus;

FIG. 5 is a schematic of the gas separator section;

FIG. 6 is a front view of the waste management section of the modular apparatus;

FIG. 7 is a schematic view of the waste management section of the modular apparatus;

FIG. 8 is a side view of the waste management section of the modular apparatus;

FIG. 9 is a process flow chart of the pressure control and waste management apparatus in a first example mode of operation;

FIG. 10 is a process flow chart of the pressure control and waste management apparatus in a second example mode of operation; and

FIG. 11 is a process flow chart of the pressure control and waste management apparatus in a third example mode of operation.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

The claimed subject matter relates to a modular apparatus 100 for removing contaminants from a borehole fluid and a method for installing the apparatus. It will be appreciated by those of skill in the art that borehole fluids include drilling fluids, completion fluids, fracturing fluids, as well as other fluids that are circulated within subterranean horeholes during the various stages of drilling, completing, and maintaining a producing wellbore. As used herein, the term “subterranean borehole” includes boreholes in drilling, completion, and production operations. The apparatus includes three components, a pressure control section 110, a gas separator section 130, and a waste management section 160.

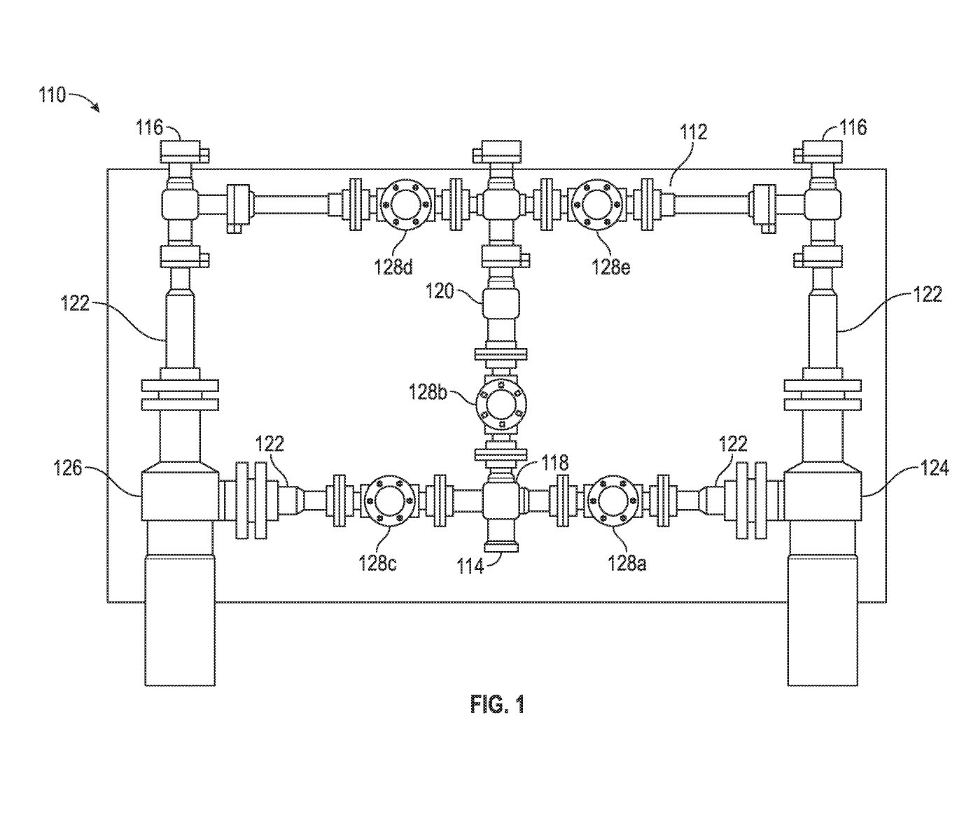

Referring to FIG. 1, the pressure control section 110 includes a pressure control manifold 118 interconnecting at least two chokes 124, 126. The chokes 124, 126 used in the pressure control section 110 are automatic chokes, providing accurate pressure control.

A plurality of valves 128a-e are placed along the manifold 118 to selectively direct fluid through the pressure control section 110. The valves 128 may be selectively opened or closed to direct fluid through a first of the chokes 124. The second choke 126 is provided as a backup, or redundant, choke in the event that the first choke 124 becomes nonfunctional for any reason. Thus, if the first choke 124 is taken off-dine for preventive maintenance, the valves 128 may be used to redirect fluid flow to the second choke 126 while the first choke 124 is repaired or maintained and the drilling process may continue uninterrupted.

The manifold 118 may include a diverter line 120. The diverter line 120 may assist in providing a third flow path in the unlikely event that the two chokes 124, 126 fail or exceed capacity or pressure limitations. Machined blast joints 122 may be used to interconnect the chokes 124, 126 and valves 128.

The manifold 118, chokes 124, 126, and valves 128 are mounted on a modular skid 112. As the entire pressure control section 110 is mounted on a single modular skid 112, it may be moved as a single piece to the desired location at the drilling site.

Used borehole fluid from the drilling operation is routed from the well to a pressure control section inlet 114. The valves 128a-c surrounding the inlet 114 will be opened or closed as appropriate to direct the used fluid through either the first choke 124 or the second choke 126. Upon exiting the first or second choke 124 or 126, the fluid will be directed to a pressure control section outlet 116. The valves 128 surrounding the outlet 116 will be opened or closed as appropriate to ensure that the used fluid exits the pressure control section 110.

In one embodiment, the chokes 124, 126 are capable of maintaining subterranean fluid pressure to within +/−50 psi of a predetermined pressure. The chokes may further include remote operating panels from which operators can set, monitor, and/or change the operating pressure within the subterranean borehole. An example of such a choke is the SUPER AUTOCHOKE™ available from M-I SWACO™.

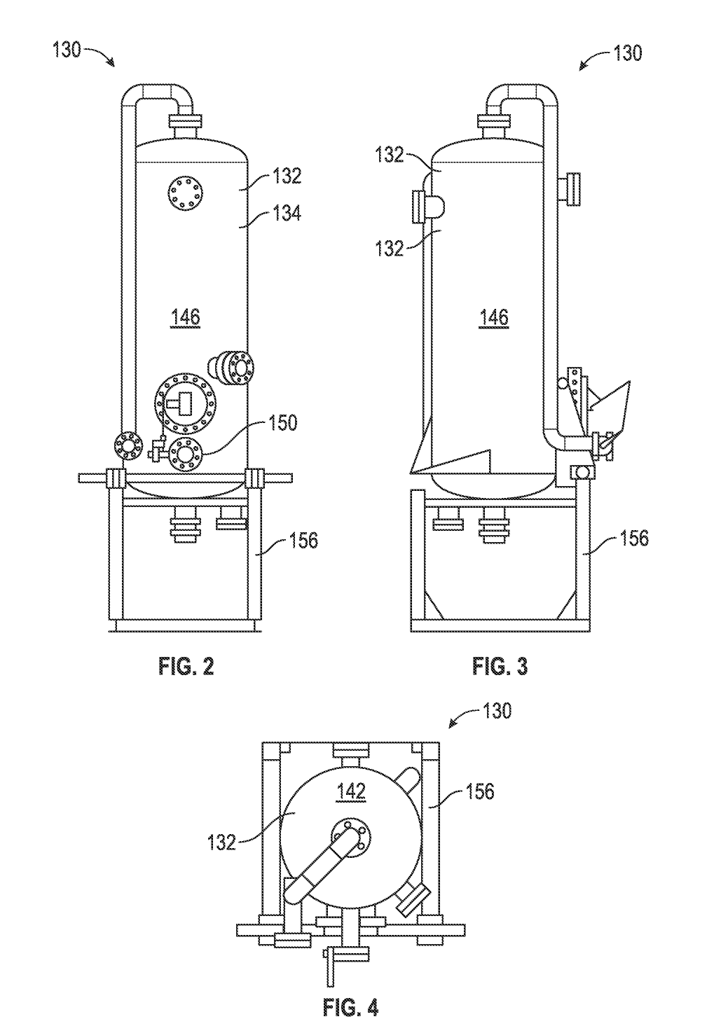

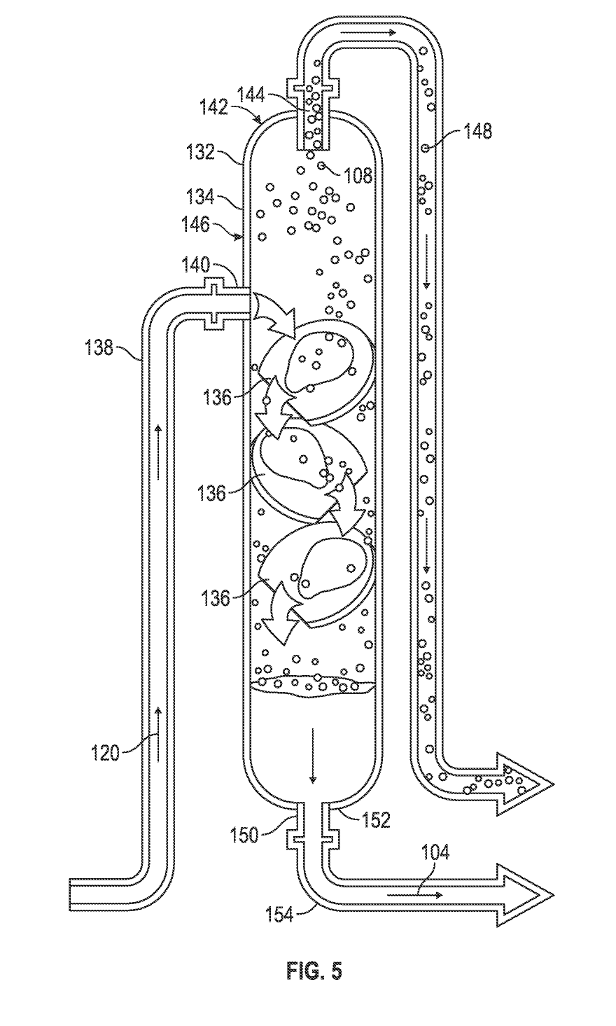

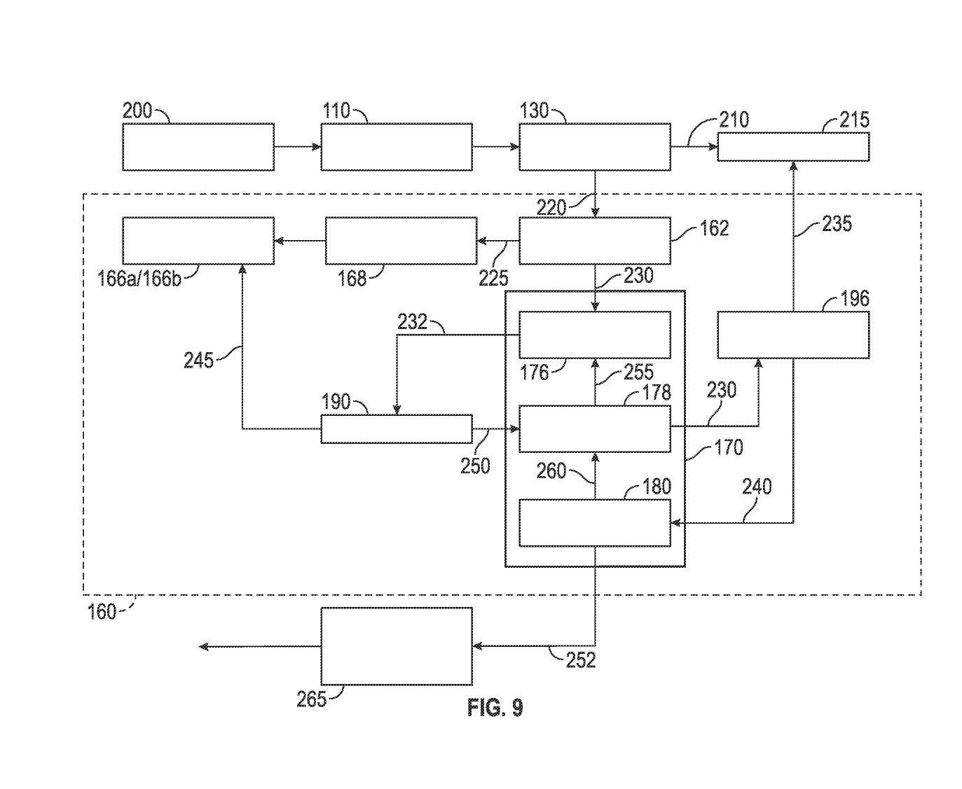

Fluid from the pressure control section 110 is directed to a gas separator section 130. FIGS. 2-4 depict a typical gas separator 132. The gas separator 132 includes a tank 134 within which a series of baffles 136 (shown in FIG. 5) are contained. Referring to FIG. 5, the contaminated borehole fluid 102 is directed through a first pipe 138 to a tank inlet 140, located near the top 142 of the tank 134. Flow inside the tank 134 is tangential to the tank wall 146, resulting in a vortex effect. The borehole fluid 102 splashes over the series of baffles 136, causing entrained gases 108 to break free. The gases 108 are released through a vent 144 in the top 142 of the tank 134. A second pipe 148 directs the gases 108 to a flare line 215 (see FIG. 9) or other safe disposal area (not shown). The degassed borehole fluid 104 is directed to a separator outlet 150 located in the bottom 152 of the tank 134, as shown in FIG. 5. Also, the separator outlet 150 may be located in the side of the tank 134, as shown in FIG. 2. A third pipe 154 directs the degassed borehole fluid 104 to the drilling waste management section 160 of the apparatus 100.

The gas separator 132 is equipped with a float to prevent overloading the separator 132 and discharge of the gas 108 over the waste management section 160.

Referring again to FIGS. 2-4, the gas separator 132 is mounted to a skid 156. The skid 156 permits the gas separator 132 to be easily positioned at the drilling site. Further, the skid 156 permits the gas separator 132 to be oriented so that the quantity of pipe 138, 148, and 154 for fluidly connecting the gas separator 132 to the pressure control section 110 and to the waste management section 160 is reduced. Degassed fluid 104 from the gas separator section 130 is gravity fed to the waste management section 160.

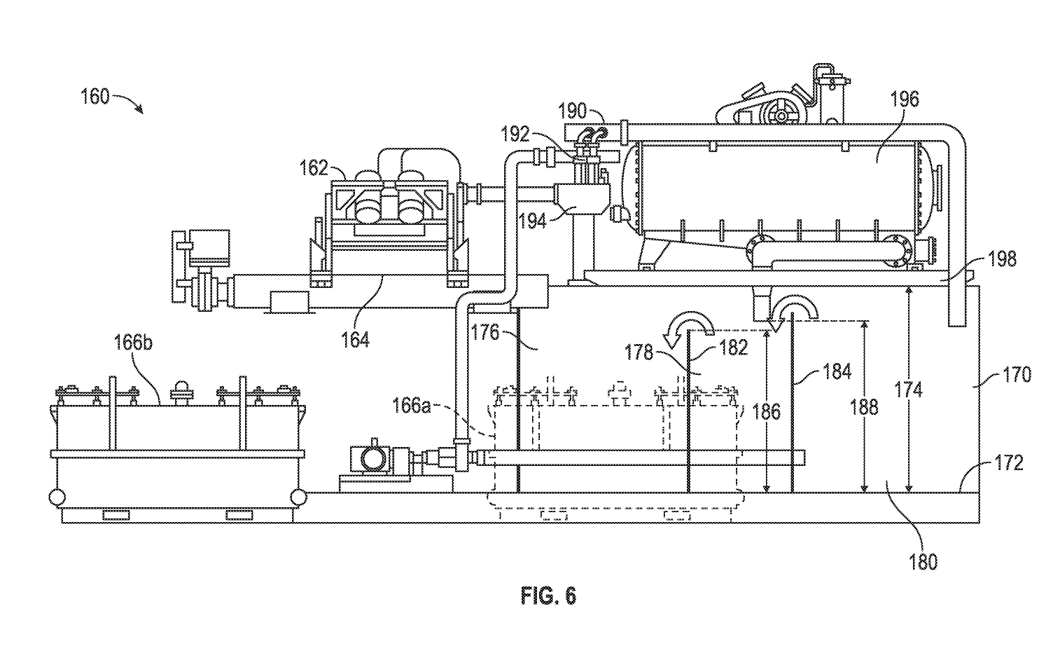

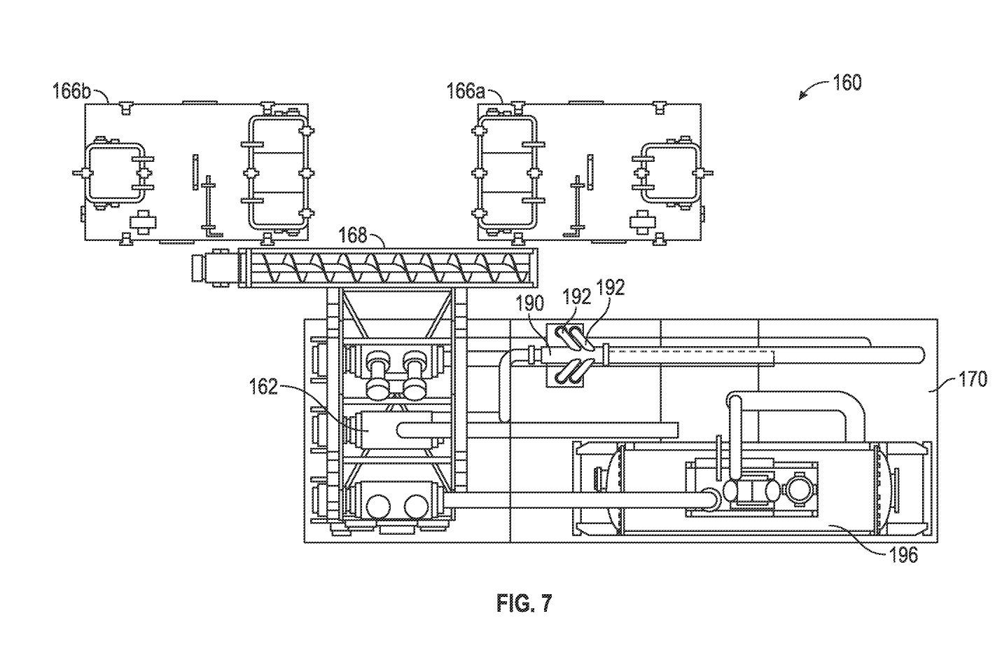

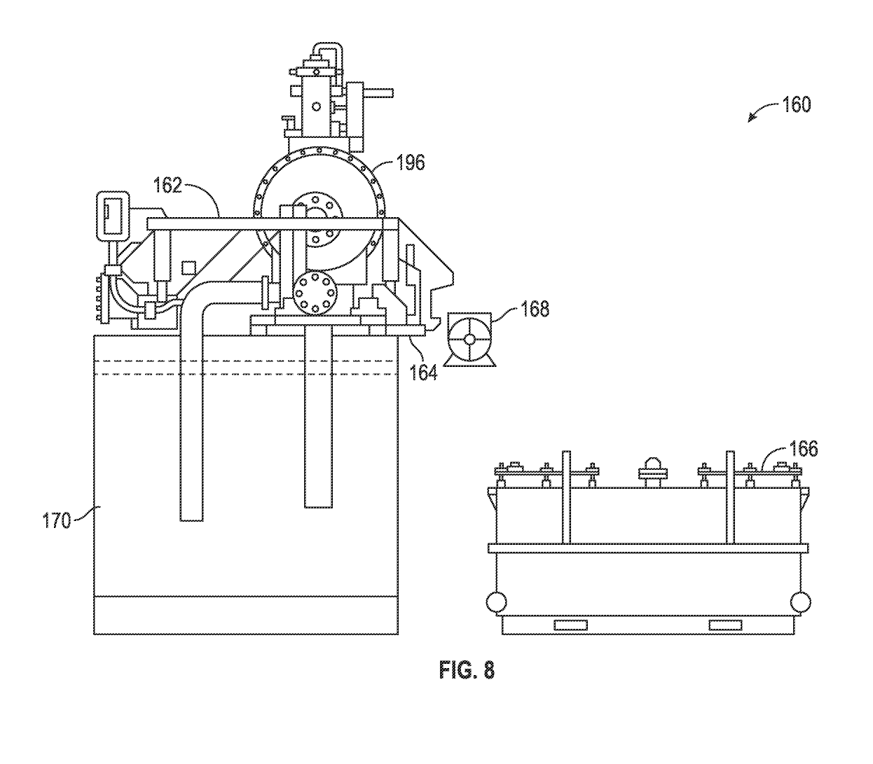

Referring to FIGS. 6-8, the waste management section 160 includes a vibratory separator 162, at least one solids collection container 166, a desilter 190, a degasser 196, and a fluid collection tank 170.

The vibratory separator 162 receives degassed fluid from the gas separator section 130. A screen (not shown) is used to separate solids (not shown) of greater than a predetermined size from the fluid. The solids are then directed to a solids collection container 166.

The vibratory separator 162 is affixed to a modular skid 164 and is positioned at an elevation above the solids collection container 166 so that gravity may be used to move the, separated solids from the vibratory separator 162 to the solids collection container 166. An auger 168 may be used also to move the solids to the solids collection container 166. Further, the auger 168 may be reversible so that a plurality of solids collection containers 166a, 166b may be used to receive solids. The auger 168 may be rotated in a first direction to feed a first solids collection container 166a until full. The rotation of the auger 168 may then be reversed to direct the solids to a second solids collection container 166b located near the opposite end of the auger 168. Thus, by reversing rotation of the auger 168 and filling another solids collection tank 166b the first solids collection container 166a may be removed and replaced without stopping the drilling process.

The fluid from the vibratory separator 162 is directed to a first pit 176 within the partitioned fluid collection tank 170. The fluid collection tank 170, located at an elevation lower than the vibratory separator 162, is partitioned into at least three pits 176, 178, 180. The fluid collected in the first pit 176 is pumped to a desilter 190, located at a higher elevation than the fluid collection tank 170.

The desilted fluid from the first pit 176 is pumped to a degasser 196, located at a higher elevation than the fluid collection tank 170. The degasser 196 removes entrained gases that were not removed in the gas separator section 130 by pumping the fluid over an internal baffle under a vacuum. From the degasser 196, the degassed fluid is directed to a second pit 178 in the fluid collection tank 170. The gases removed from the fluid are vented. The gases may be directed to the second pipe 148 from the gas separator 132 (shown in FIG. 5), which guides the gases to a flare line (not shown).

The degasser 196 is affixed to a modular skid 198. The skid 198 allows the degasser 196 to be conveniently located over the fluid collection tank 170 such that the, fluid is directed to the second pit 178 without excess piping.

The desilter 190 is used to remove additional solids from the fluid pumped from the second pit 178. The fluid is directed through a plurality of hydrocyclones 192 where the solids not separated by the vibratory separator 162 are forced toward the inside surface of the hydrocyclone 192. The solids spiral downward and are discharged by the hydrocyclones 192 into a trough 194. The trough 194 may direct the solids, much of which has been compressed to form a larger solid, back to the vibratory separator 162 for drying and reclamation of uncontaminated borehole fluid. In another embodiment, the solids separated by the desilter 190 may be directed to one of the solids collection containers 166a or 166b. The desilted fluid is directed to a third pit 180 of the fluid collection tank 170.

A first partition 182 separates the first pit 176 and the second pit 178. The first partition 182 extends from the tank floor 172 to a first partition height 186 that is less than the tank height 174 of the fluid collection tank 170. The second pit 178 has a second pit fluid capacity dependent upon the first partition height 186. Thus, it is possible for fluid to be communicated between the first and second pits 176, 178 when fluid into the second pit 178 exceeds the second pit fluid capacity.

The second partition 184, separating the second pit 178 from the third pit 180, has a second partition height 188 that is less than the tank height 174 but greater than the first partition height 186. Thus fluid may be communicated from the third pit 180 into the second pit 178. The third pit 180 has a third pit fluid capacity dependent upon the second partition height 188. When fluid into the third pit 180 exceeds the third pit fluid capacity, fluid will overflow the second partition 1.84 and be communicated to the second pit 178. Under normal operating conditions, fluid will not be communicated from the second pit 178 to the third pit 180, as the first partition 182 is shorter than the second partition 184. Fluid overflow from the second pit 178 will first be communicated to the first pit 176. When the first and second pits 176, 178 are full, the fluid is communicated into the third pit 180 from the second pit 178.

Fluid from the third pit 180 is pumped to the active rig pumps for recirculation down the borehole. Because the first and second partition heights 186, 188 differ, overflow fluid from the third pit 180 is directed to the second pit 178 and is continually recirculated through the degasser 196 to ensure all entrained gases are removed from the fluid.

As one of skill in the art can appreciate, the apparatus 100 described may be used in the operation of many types of subterranean activities. The pressure control and waste management capabilities of the apparatus 100 may be effectively used in coiled tubing operations such as drilling, fracturing, completion, and underbalanced drilling. The apparatus 100 may also be effectively used for well intervention and managing the waste and pressure associated with traditional drill pipe operations. The modular design provides flexibility for placement near the borehole. As previously described, the pressure control section 110 provides redundant pressure control for subterranean borehole fluids. The waste management section 160 provides a closed loop process for removing solids and gases from borehole fluids and returning them to the borehole.

The apparatus 100 may be run in various different modes of operation or processes.

Referring to FIG. 9 which shows a first or normal mode of operation, the process performed by the apparatus 100 is schematically demonstrated. The first mode of operation may be used to process a mixture comprising fluids, solids and methane gas. Fluid pressure of the fluid 200 in the borehole is maintained by pressure control section 110. The fluid 200 from the borehole is directed through the pressure control section 110 to the gas separator section 130. Gases 210 released from the fluid at the gas separator section 130 are vented via a flare line 215. The degassed fluid 220 is directed to the vibratory separator 162 of the waste management section 160 which may be mounted on a mobile apparatus (e.g., a trailer) and may comprise a plurality of components as discussed below. The vibratory separator 162 separates large solids 225 from the degassed fluid 220. The separated solids 225 are directed via an auger 168 to a solids collection container 166a or 166b. Fluid 230 from which solids 225 are separated at the separator 162 is directed into a first pit 176 of the fluid collection tank 170. Thereafter, the fluid 232 may be directed to a desilter 190 which removes additional finer solids 245 from the fluid 240. The solids 245 removed by the desilter 190 are directed to the solids collection container 166a or 166b. The desilted fluid 250 is directed to a second pit 178 of the fluid collection tank 170. The fluid 230 at the second pit 178 is then directed to a degasser 196 where residual entrained gases 235 are removed from the fluid and vented at the flare line 215. The degassed fluid 240 is directed from the degasser 196 to a third pit 180 of the fluid collection tank 170. From the third pit 180, the fluid 252 may be recirculated into the rig pump 265. When fluid 240 directed to the third pit 180 exceeds the capacity of the third pit 180, overflow 260 is directed to the second pit 178. Likewise, when fluid 250 into the second pit 178 exceeds the capacity of the second pit 178, overflow 255 is directed to the first pit 176. Thus, when fluid 255 or 260 overflows to previous pit 176 or 178, respectively, the fluid is desilted or degassed a second time before ultimately being sent to rig pumps 265 that recirculate the fluid 252 to the borehole.

The apparatus 100 described may be easily transported to the drill site and plumbed. The fluid collection tank 170 and the solids collection containers 166a, 166b are positioned at elevations below the elevations of the vibratory separator 162, the desilter 190, and the degasser 196. The vibratory separator 162 is located at an elevation below the gas separator 132 and the desilter 190, as both of these units use gravity to feed the vibratory separator 162. The auger 168, if included, is positioned such that it is fed from the vibratory separator 162 by gravity and such that it feeds the solids collection containers 166a, 166b by gravity. Thus, the auger 168 will be located at an elevation below the solids discharge of the vibratory separator 162 and above the opening of the solids collection containers 166a, 166b.

To prepare the apparatus 100, the skid mounted equipment is removed from the transportation provider and placed at the rig location. Transportation of the equipment may occur using one or more lifts. For example, the entire unit may be transported as one except of the choke and the manifold. The equipment located at lower elevations, i.e. the fluid collection tank 170 and the solids collection container 166, is removed and placed at the site first. The desilter 190 and degasser 196 may be moved next and plumbed to the corresponding pits 176, 178, 180 in the fluid collection tank 170. Next, the vibratory separator 162 and auger 168 may be positioned and aligned appropriately. Finally, the gas separator section 130 and the pressure control section 110 may be positioned and plumbed to the equipment already assembled.

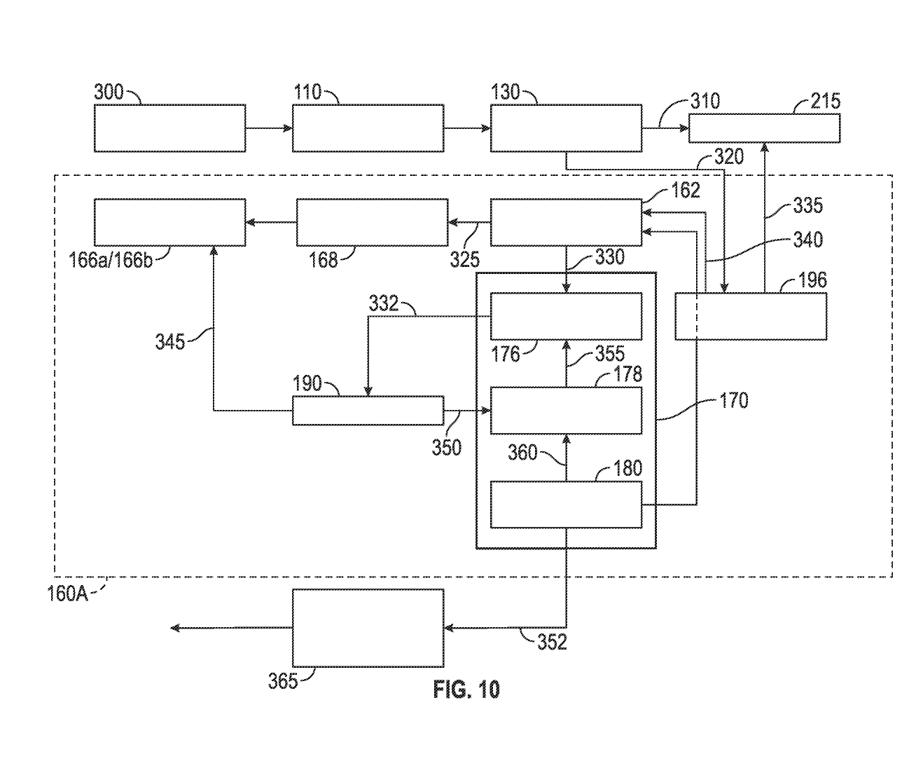

FIG. 10 schematically shows a second mode of operation which may be used to separate hydrogen sulfide or high concentrations of other types of gases such as corrosive oxygen, etc. from the fluid. The pressure of the fluid 300 from the borehole is controlled at the pressure control section 110 and reaches the gas separator section 130. At the gas separator section 130, gases 310 are released from the fluid 300 and are vented via the flare line 215. The degassed fluid 320 is thereafter directed to the degasser 196 of the wage management section 160A that is located downstream of the gas separator section 130. The waste management section 1160A may be mounted on a mobile apparatus such as a trailer. The degasser 196 removes residual entrained gases 335 that are vented to the flare line 215. The degassed fluid 340 from the degasser 196 is directed to the vibratory separator 162 that separates large solids 325 from the degassed fluid 330. The separated solids 325 may be directed to the solids collection container 166a or 166b via an auger 168. The fluid 330 from the separator 162 is directed to a fluid collection tank 170 which may contain a plurality of pits. For example, the fluid 330 may be directed to the first pit 176 and the fluid 332 from the first pi 176 may be directed to the desilter 190 to separate finer solids from the fluid 332. From the desilter 190, the finer solids 345 are sent to the solids collection container 166a or 166b while the desilted fluid 350 is directed to the second pit 178. When fluid 240 directed to the third pit 180 exceeds the capacity of the third pit 180, overflow 260 is directed to the second pit 178. Likewise, when fluid 250 into the second pit 178 exceeds the capacity of the second pit 178, overflow 255 is directed to the first pit 176. Moreover, the fluid in the third pit 180 may be directed to the vibratory separator 162. The fluid 352 collected in the fluid collection tank 170 may be further directed to rig pumps 365 that recirculate the fluid to the borehole.

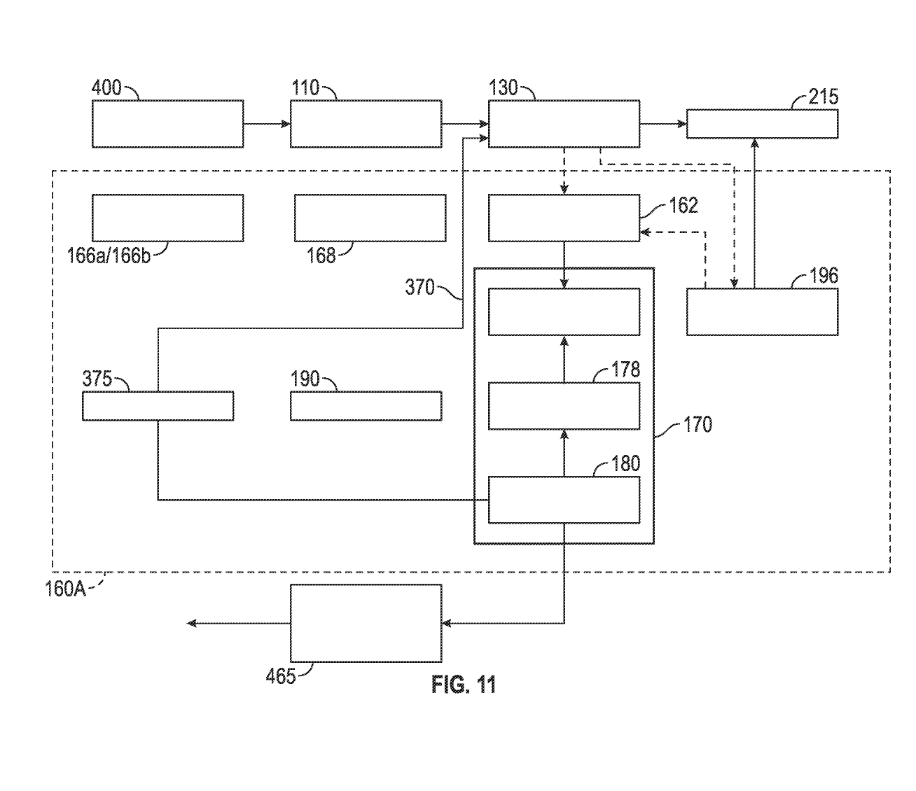

FIG. 11 schematically shows a third mode of operation and may omit sonic of the features shown in FIGS. 9-10 for clarity of illustration, FIG. 11 shows the fluid 400, the gas separator section 130, the flare line 215, the waste management section 160B, the vibratory separator 162, the degasser 196, the solids collection containers 166a, 166b, the desilter 190, the fluid collection tank 170 with the first pit 176, the second pit 178 and the third pit 180, and the rig pump 465. The third mode may be used to prevent the gas separator section 130 from being empty as such a state could cause gas to be sucked from the flare line 215 and be discharged with the fluid. The third mode may be automatically activated if a level sensor in the gas separator section 130 detects a low level of fluid. In the third mode, when fluid or mud level in the gas separator section 130 is low, fluid 370 from one of the pits of the fluid collection tank 170 (e.g., the third pit 180) may be drawn to fill the gas separator section 130 as shown in FIG. 11. The supply of the fluid may be generated using a centrifugal pump 375 and may be controlled automatically or manually. Such a process of supplying fluid from one of the pits to the gas separator section 130 may be used in conjunction with the configuration of FIG. 9 or 10. In order to provide a liquid seal of the gas separator section 130, the supply of fluid from the gas separator section 130 to the vibratory separator 162 may he conducted through a U-tube or a valve control using a float hall.

In a first example aspect, an apparatus comprises a pressure control section, a gas separator section and a waste management section. The pressure control section is in fluid communication with a subterranean borehole and controls an operating pressure of fluid in the borehole. The fluid comprises solids and entrained gas. The gas separator section is in fluid communication with the pressure control section. The gas separator section removes entrained gas from the fluid. The waste management section comprises a degasser section, a vibratory separator, and a collection tank. The degasser section receives fluid from the gas separator section. The vibratory separator receives the degassed fluid from the degasser section. The degasser section is operable to remove gases entrained in the fluid while communicating the degassed fluid to the vibratory separator. The collection tank comprises a first pit that receives the separated fluid from the vibratory separator. The separated fluid is circulated back from the collection tank to the subterranean borehole.

In a second example aspect, an apparatus comprises a pressure control section, a gas separator section and a waste management section. The pressure control section is in fluid communication with a subterranean borehole and controls an operating pressure of fluid in the borehole. The fluid comprises solids and entrained gas. The gas separator section is in fluid communication with the pressure control section. The gas separator section removes entrained gas from the fluid and comprises a level sensor to sense a level of fluid in the gas separator section. The waste management section comprises a degasser section, a vibratory separator and a collection tank. The degasser section is operable to remove entrained gases from the fluid. The vibratory separator is in fluid communication with the degasser section.

At least one of the degasser section and the vibratory separator receiving is degassed fluid from the gas separator section. The collection tank comprises at least a pit. The at least one pit receives the separated fluid from the vibratory separator. The separated fluid is circulated back from the at least one pit to the gas separator section when the level sensor indicates the level of fluid is low.

In a third example aspect, a method comprises controlling an operating pressure of a fluid from a borehole. The fluid comprises solids and entrained gas. The method also comprises removing entrained gas from the fluid at an upstream location. The method also comprises removing entrained gas from the fluid at a downstream location. The method also comprises separating solids from the fluid. The method also comprises circulating the separated fluid back to the borehole. The separating of solids occurs after the removing of entrained gases from the fluid at the downstream location.

In a fourth example aspect, a method comprising controlling an operating pressure of a fluid from a borehole. The fluid comprises solids and entrained gas. The method also comprises removing entrained gas from the fluid. The method also comprises preparing the fluid for recirculation to the borehole. The preparing comprising separating solids from the fluid, collecting the separated fluid, and circulating the separated fluid back to remove entrained gas. The method also comprises circulating the separated fluid back to the borehole.

Although the preceding description has been described herein with reference to particular means, materials, and embodiments, it is not intended to be limited to the particulars disclosed herein; rather, it extends to all functionally equivalent structures, methods, and uses such as are within the scope of the appended claims.

What is claimed is:

1. An apparatus comprising:
a pressure control section in fluid communication with a subterranean borehole and controlling an operating pressure of fluid in the subterranean borehole, wherein the fluid comprises solids and entrained gas;
a gas separator section in fluid communication with the pressure control section, wherein the gas separator section removes at least a portion of the entrained gas from the fluid; and
a waste management section comprising:
a degasser section degassing at least a portion of the fluid from the gas separator section to produce degassed fluid;
a vibratory separator receiving the degassed fluid from the degasser section, the degasser section communicating the degassed fluid to the vibratory separator; and
a collection tank comprising a first pit that receives the separated fluid from the vibratory separator;
wherein the separated fluid is circulated back from the collection tank to the subterranean borehole.

2. The apparatus of claim 1, further comprising a flare line receiving the removed entrained gases from the gas separator section.

3. The apparatus of claim 2, wherein the flare line receives the entrained gases from the degasser section.

4. The apparatus of claim 1, wherein the waste management section further comprises a desilter receiving the fluid from a first pit of the collection tank and operable to remove additional solids from the fluid, the solids are directed to a solids collection area and the desilted fluid is communicated to a second pit of a collection tank.

5. The apparatus of claim 4, further comprising a solids collection container receiving the separated solids from the vibratory separator and the desilter.

6. The apparatus of claim 4, wherein a first partition having a first partition height separates the first pit and the second pit in the collection tank and the second pit has a corresponding fluid capacity, wherein fluid can be communicated to the first pit from the second pit over the first partition when fluid in excess of fluid capacity of the second pit is directed to the second pit.

7. The apparatus of claim 6, wherein the collection tank comprises a third pit, a second partition having a second partition height separates the third pit and the second pit in the collection tank and the third pit has a corresponding fluid capacity, wherein fluid can be communicated to the second pit from the third pit over the second partition when a fluid in excess of fluid capacity of the third pit is directed to the third pit.

8. An apparatus comprising:
a pressure control section in fluid communication with a subterranean borehole and controlling an operating pressure of fluid in the borehole, wherein the fluid comprises solids and entrained gas;
a gas separator section in fluid communication with the pressure control section, wherein the gas separator section removes at least a portion of the entrained gas from the fluid and comprises a level sensor to determine a level of fluid in the gas separator section; and
a waste management section comprising:
a degasser section operable to remove entrained gases from the fluid;
a vibratory separator in fluid communication with the degasser section, at least one of the degasser section and the vibratory separator receiving degassed fluid from the gas separator section; and
a collection tank comprising at least one pit, the at least one pit receiving separated fluid from the vibratory separator;
wherein the separated fluid is circulated back from the at least one pit to the gas separator section in response to the sensor indicating that the level of fluid is low.

9. The apparatus of claim 8, wherein the collection tank comprises a first pit, a second pit and a third pit, the first pit receiving separated fluid from the vibratory separator, the waste management section further comprising a desilter receiving fluid from the first pit and operable to remove additional solids from the fluid, the solids directed to a solids collection area and the desilted fluid communicated to the second pit.

10. The apparatus of claim 9, wherein, when the sensor indicates the level of fluid is low, the fluid is circulated back from the third pit to the gas separator section.

11. The apparatus of claim 9, wherein a first partition having a first partition height separates the first pit and the second pit in the collection tank and the second pit has a corresponding fluid capacity, wherein fluid can be communicated to the first pit from the second pit over the first partition when fluid in excess of fluid capacity of the second pit is directed to the second pit.

12. The apparatus of claim 11, wherein a second partition having a second partition height separates the third pit and the second pit in the collection tank and the third pit has a corresponding fluid capacity, wherein fluid can be communicated to the second pit from the third pit over the second partition when a fluid in excess of fluid capacity of the third pit is directed to the third pit.

13. A method comprising:
controlling an operating pressure of a fluid, the fluid comprising solids and entrained gas;
removing at least a portion of the entrained gas from the fluid at an upstream location;
removing residual entrained gas from the fluid at a downstream location; and
separating at least a portion of the solids from the fluid to produce separated fluid,
wherein the separating of solids occurs after the removing of residual entrained gases from the fluid at the downstream location.

14. The method of claim 13, further comprising venting the entrained gas removed at the upstream location and venting the entrained gas removed at the downstream location.

15. The method of claim 13, further comprising circulating the separated fluid back to the borehole and collecting the separated fluid before the separated fluid is circulated back to the borehole.

16. The method of claim 15, further comprising separating finer solids from the separated fluid and collecting the separated solids.

17. A method comprising:
controlling an operating pressure of a fluid from a borehole, the fluid comprising solids and entrained gas;
removing at least a portion of the entrained gas from the fluid; and
preparing the fluid for recirculation to the borehole, the preparing comprising:
separating at least a portion of the solids from the fluid;
collecting the separated fluid; and
circulating the separated fluid back to remove at least a portion of the entrained gas;
circulating the separated fluid back to the borehole.

18. The method of claim 17, further comprising separating solids from the fluid prior to the preparing, wherein the separating as part of the preparing separates finer solids.

19. The method of claim 17, wherein the preparing comprises removing residual entrained gas from the separated fluid.

20. The method of claim 19, wherein, as part of the preparing, the separating occurs prior to the removing.
